(19) United States
(12) Patent Application Publication
(10) Pub. No.: US 2018/0128610 A1
(43) Pub. Date: May 10, 2018

(54) PITCH MEASURING DEVICE AND METHOD FOR CHECKING AN ADJUSTMENT PRECISION OF A COMPONENT MOVING ON A MOTION PATH

(71) Applicant: DREIER Technology GmbH, Horb-Bittelbronn (DE)

(72) Inventor: Horst Dreier, Horb-Bittelbronn (DE)

(21) Appl. No.: 15/800,283

(22) Filed: Nov. 1, 2017

(30) Foreign Application Priority Data
Nov. 4, 2016 (EP) EP16197219.5

(51) Int. Cl. G01C 9/16; G01D 5/347; G01D 5/244

(52) U.S. Cl. CPC G01C 9/16; G01C 9/12; G01D 5/24485; G01D 5/3473

(57) ABSTRACT

A pitch measuring device for checking a positioning precision of an operating spindle or an operating table of a machine, e.g. of a NC machine tool moving along an at least two dimensional movement path, the pitch measuring device including a measuring device including a rotary encoder and an electronics unit detecting an angular position of a housing base element relative to a housing top element wherein the measuring device is attachable at a machine arm receiving the operating spindle or at a machine table. Additionally a pendulum element can be used that is connected in a rigid manner with the measuring device and which includes a pendulum element with an integrated first inclination sensor which is supplemented by a second inclination sensor which is directly attachable at frame element of the machine.

### RELATED APPLICATIONS

This application claims priority from and incorporates by reference European Patent Application EP 16 197 219.5 filed on Nov. 4, 2016.

### FIELD OF THE INVENTION

The invention relates to a pitch measuring device and method for checking an adjustment precision of a component moving on an at least two dimensional movement path, the pitch measuring device comprising a housing including attachment devices for attachment at the machine element and an integrated measuring device which is arranged in the housing and a centrally arranged rotation shaft and a rotary encoder for detecting an angle position of the rotary encoder relative to the rotation shaft and a method for checking the positioning precision using the measuring device.

### BACKGROUND OF THE INVENTION

Current requirements with respect to precision of machine tools, for example numerically controlled machine tools require that also rotation axes like e.g. an A-, B- and C- axis of numerically controlled machine tools have to be measured and optimized in the best way possible in addition to linear axes. This has also become necessary in particular because rotation axes have a significant impact upon fabrication precision for current five-axis fabrication.

Therefore a cone shaped certification sample is typically produced as a certification sample for a machine of this type instead of a cylindrical certification sample. Thus it is required that an eccentricity measured at the work piece is less than 10 μm.

High precisions of this type require that the positioning precision of the linear axes as well as rotation axes have to be adapted to each other in an optimum manner. Therefore it is important that the rotation axes are measured in addition to the linear axes during machine acceptance trails and that the machine control is corrected accordingly. The required precisions are only achieved when the linear axes are measured and optimized with a laser pitch measuring device and the rotation and pivot axes are measured with a highly precise pitch measuring device with a system precision of ±1 arcsec. which is achieved by 30,000 measuring points per 360° of the rotary encoder.

It is also generally known that machines of this type and their foundations slope more or less backward, forward or sideways through weight displacement. Machining imprecisions typically only occur when the machine is tilted in its entirety. In order to determine the inclination of the machine the inclination is typically measured with a pitch measuring device.

Pitch measuring devices of the general type described supra are known in the art. Reference is made for example to the pitch measuring device TGM 8088 fabricated and sold by the applicant which is considered the most pertinent prior art. This known highly precise pitch measuring device includes a housing which includes an adapter plate through which the housing can be fixed at a rotating portion for example of a numerically controlled machine tool like e.g. a machine table, tool spindle, machine arm or similar for each application. The housing of the pitch measuring device thus performs the movements of the movable machine component. In the housing there is a measuring device which includes a centrally arranged rotation shaft and a rotary encoder. Rotary encoders are sensors for rotation angle detection which typically supply digital output signals which have to be decoded at another end of the sensor line in a processing unit. In this case the sensors are designated as encoders or rotary encoders. As a matter of principle the output signals can be digital or analog sine or cosine signals. The rotation shaft protrudes from the housing top side and is fixed during the measurement by a scanning rod arrangement at a fixed machine element. During measurement the housing rotates relative to the fixed rotation shaft so that a movement of the movable machine component can be detected. For the measurement a plurality of angular positions is approached by the machine control and measured. The pitch measuring device detects actual angular positions and a deviation from a preset value in the machine control or nominal position is determined. These differences are entered into the machine control after finishing the measurement and thus the position deviations are compensated so that a highly precise machining of work pieces can be provided according to the corrected machine control.

### BRIEF SUMMARY OF THE INVENTION

It is an object of the invention to improve the known pitch measuring device with respect to the configuration so that in addition to the current measurements also other influences upon the measurement can be considered and the measurements can be performed with higher precision.

The object is achieved according to the invention by a pitch measuring device for checking a positioning precision of a machine element of a machine, the machine element moving along an at least two dimensional movement path, the pitch measuring device comprising a housing including attachment devices for attachment of the housing at the machine element, an integrated measuring device that is arranged in the housing, a centrally arranged rotation shaft, a rotary encoder for detecting an angular position of the rotary encoder relative to the rotation shaft, wherein the housing includes a housing base element and a housing top element that is rotatably arranged relative to the housing base element through the rotation shaft that is centrally arranged and attached torque proof at the housing base element, wherein the rotary encoder is arranged in the housing top element and the housing base element includes the attachment devices.

The object is also achieved by a method comprising the steps moving a machine element of a machine along a movement path that is at least two dimensional; and checking a positioning precision of the machine element by a pitch measuring device, the pitch measuring device including a housing including attachment devices for attachment of the housing at the machine element, an integrated measuring device which includes a centrally arranged rotation shaft and a rotary encoder in the housing for detecting an angular position of the rotary encoder relative to the rotation axle, wherein the housing is arranged at the machine element performing the movement path with the horizontal rotation shaft, wherein a first inclination sensor is arranged at the housing and a second inclination sensor is arranged at a frame element of the machine and data provided by the first inclination sensor and the second inclination sensor during a position change of the machine is computed with data determined by the rotary encoder.

Accordingly the pitch measuring device according to the invention includes a housing with a housing base element in order to check positioning precision and a housing top element that is arranged rotatable relative to the housing base element by a centrally arranged rotation shaft that is arranged torque proof at the housing base element, wherein the rotary encoder and the electronic control unit are arranged in the housing top element and the housing base element includes the attachment devices. Thus, the housing top element is the stationary element where the scanning rod arrangement is attached, wherein the housing top element is advantageously configured larger than the housing base element. The housing base element rotates with the movable machine element so that the rotation angles of the rotation shaft attached at the housing base element can be detected relative to the housing top element and displayed and/or entered directly into the machine control with corresponding software. Advantageously a rotary encoder with proprietary support is used.

Advantageously the housing top element includes a clamping pin that is aligned with the axis of the rotation shaft. Like in the prior art this clamping pin is used for attaching the scanning rod arrangement which is fixed through a clamping element at the clamping pin and at another end at a non-movable part of the machine. Thus, also the housing top element is fixed during the measurement so that it does not perform any rotation. Attaching the scanning rod arrangement as precisely as possible in the axis of the rotation shaft is also important in order to prevent measuring errors.

According to an advantageously embodiment of the invention the housing top element includes a housing cover and a housing jacket. This configuration facilitates a compact configuration of the pitch measuring device which is also smaller than the prior art with respect to circumference and diameter. The housing cover facilitates on the one hand side easy access to elements within the housing and furthermore facilitates attaching connection devices configured as plug in connectors and printed circuit boards and connections to the connection devices and the measuring device on a back side of the housing cover. Advantageously the housing top element includes electrical connection devices for different operating modes, wherein the electrical connection devices are advantageously configured as plug in connectors. The plug in connectors can be for example connection jacks for respective plugs with different pole numbers.

Advantageously an embodiment of the pitch measuring device according to the invention is used where the housing base element includes a base with a pressure plate and with an adjustment plate, wherein the adjustment plate is provided for adjustment at the machine element. The pressure plate clamps a rotation shaft base arranged at a base end of the rotation shaft wherein the clamping is performed by adjustment plate. Alignment devices are arranged between the adjustment plate and the pressure plate wherein the alignment devices facilitate centering the rotation shaft and thus also the housing top element. Thus a precise positioning of the housing relative to the movable machine element can be implemented. As already stated supra the corresponding adapter elements provide a quick attachment of the housing for any application which is also precise with respect to the relevant axes.

Using an external data unit that is connectable with a computer and which is connectable or connected with the respective plug connector and/or at additional measuring elements providing actual values is advantageously implemented. Accordingly the determined actual values and the target values and the differences are displayed on a computer and the differential value is then entered into the machine control by hand or already considered in the machine control directly through a corresponding software. Typically the actually entered value is determined based on static processing.

A particularly advantageous embodiment of the pitch measuring device according to the invention includes an inclination sensor which is advantageously integrated in a pendulum element which is fixed or removably fixed at the clamping pin. This inclination sensor is subsequently designated as a first inclination sensor. This inclination sensor is required for measuring horizontal rotation axes. It is an object of the pendulum element with the first inclination sensor to support the upper housing element in the vertical starting position, this means to rotate the upper housing element back into the starting position when the rotation axle is rotated. The pendulum element is advantageously configured a rod shaped and elongated, in particular with a rectangular cross sectional shape, fixed at the housing top element and protrudes in a radial direction of the top element beyond an outer circumference of the measuring device. During measurements with the pendulum element the pitch measuring device does not have to be aligned 100% concentric with the rotation axis. Due to the friction there is a possibility that the pendulum element is not oriented exactly vertical. For this purpose the inclination sensor in the pendulum element is required. The inclination sensor indicates the deviation of the pendulum element or the housing top element. The deviations thus determined are corrected during the measurement.

In addition to the first inclination sensor the pitch measuring device includes a second inclination sensor which has to he attached remote from the measuring device at the machine, for example at a frame or machine stand etc. of the machine. Before the measurement all measurement values of the rotary encoder and of the two inclination sensors are set to zero in the computer. When the position of the entire machine changes the measurement values of the rotary encoder and of the two inclination sensors change. The changes are computed with each other so that the measurement is not influenced. The same occurs when the frame of the machine is warped. The second inclination sensor is integrated in a housing element. Advantageously a second pendulum element with an integrated inclination sensor is used as a second inclination sensor wherein the second pendulum element is configured according to the pendulum element for the housing top element. Without the second pendulum element there are significant measurement errors. Advantageously oil damping can also be provided in the pendulum elements in order to prevent undesirable resonance movements of the pendulum element due to vibrations in the machine.

In one embodiment of the invention the housing top element and/or the housing base element advantageously has an essentially cylindrical shape. The housing top element can be used with or without pendulum element, this means with or without the inclination sensor. In order to be able to use the inclination sensor that is received in the pendulum element the elongated pendulum element has to extend vertically after fixating the measuring device at the machine, thus the housing base element has to be arranged so that the rotation shaft extends horizontally. When using the measuring device without the pendulum element the orientation of the housing base element is at will, this means the rotation shaft can extends in any direction in space during the assembly which is not possible for pitch measuring devices that are laser based or provided with a leveling device.

In an advantageous embodiment of the invention the housing top element respectively includes an individual plug connector as a data output for the rotary encoder and an individual plug connector as a data input for the inclination sensor arranged at the housing top element. Since the housing top element is stationary entangling the feed wiring is not possible so that any number of rotations can be performed.

In another advantageous embodiment of the pitch measuring device according to the invention the housing base element can include a combined data output for the rotary encoder and the inclination sensor which is configured as a combination plug connector. This facilitates transmitting the measurement data for example to a data unit or a computer.

A conductor cable can run for example from the combination plug connector arranged at the housing base element for example to the housing top element. This, however, has the disadvantage that a rotation of the housing top element relative to the housing base element leads to a twisting of the cable. Thus, a number of rotations of the housing top element relative to the housing base element is limited. In order to solve this problem the combination plug is connected through slip contacts with the housing top element in an advantageous embodiment of the invention so that the signals of the rotary encoder and of the first inclination sensor connected at the housing top element are captured by the slip contacts. This facilitates any number of revolutions. Thus, the slip contacts are electrically connected with the individual plug connectors forming the connection devices and/or the electronic control unit through a multi-track slip ring.

The pitch measuring device according to the invention can also be operated without a pendulum element with integrated inclination sensor that is arranged on top at the housing base element of the measuring device as stated supra. Thus, a scanning rod arrangement can be removably attached at the clamping pin by a clamping element alternatively to the pendulum element.

In an embodiment of the invention an external A/D convertor that is connectable with a computer is provided in addition to the measuring device wherein the individual plug connectors or the combination plug connector of the measuring device and/or the second inclination sensor are connectable with the A/D converter through a plug connection. The A/D convertor is used to convert the analog input signals into digital signals. The A/D convertor is connected on the output side with the computer which takes over the data or at least stores them in an intermediary manner and provides the actual processing of the measuring data and their visualization. The rotary encoder and the first and second inclination sensor can also be connected with the A/D convertor directly.

According to the method according to the invention for checking positioning precision of a machine element moving along a movement path that has at least two dimensions, in particular of a horizontal rotation axis of a machine, for example of a NC controlled machine tool by a pitch measuring device wherein a housing of the pitch measuring device is arranged at the machine element moving along the movement path with a horizontal rotation shaft, it is provided that a first inclination sensor is arranged at the housing of the pitch measuring device and a second inclination sensor is arranged at a frame element of the machine and data provided by the inclination sensors is used to correct the data determined by the rotary encoder during a position change of the machine. This is advantageously performed so that the deviations from the original position at the beginning of the measurement that are provided by the inclination sensors are added to or subtracted from the values provided from the rotary encoder. The addition or subtraction depends on the direction or deviation from the horizontal position. Thus also a friction between the rotation shaft and the rotary encoder can be detected and considered. The method can be performed as a matter of principle with a pitch measuring device as described supra, but also with another suitable pitch measuring device including corresponding inclination sensors.

According to another embodiment of the method all measurement values of the rotary encoder and of the two inclination sensors are set to zero in the computer before the measurement. When a position of the entire machine changes the measurement values of the rotary encoder and of the two inclination sensors change. These changes are computed with each other so that the measurement is not influenced. The same occurs when the frame of the machine is warped. Advantageously the data is corrected outside of the housing of the pitch measuring device according to the invention when the method according to the invention is performed.

The pitch measuring device according to the invention is configured simple and compact, can be produced and used in a precise and efficient manner and it is quite economical. It is useable in all positions and attachable at the machines at any slant angle. Furthermore the pitch measuring device is suitable for measuring rotation axes without an additional laser measuring device or bubble level and it is usable in many positions where other measuring devices reach their limits. The pitch measuring device according to the invention allows an unlimited number of revolutions with a smallest measuring step 0.0001° or 0°00′01.1″. In addition to the prevailing measurements without pendulum the pitch measuring device according to the invention also facilitates measurements with a pendulum element when imprecise values are to be expected through the position change of the rotation axis to be measured. The pendulum element can be attached at the housing of the pitch measuring device in a simple manner and then moves about the rotation axis relative to the housing top element. The method according to the invention facilitates more precise measurement in particular for systems where a displacement of the machine element through its own weight is to be expected.

### BRIEF DESCRIPTION OF THE DRAWINGS

The invention is subsequently described in more detail based on an embodiment with reference to drawing figures. Additional features of the invention can be derived from the subsequent description of the embodiment of the invention in combination with the claims and the appended drawing figures. The individual features of the invention can be implemented individually or in combination in different embodiments of the invention, wherein:

FIG. 1 illustrates a perspective view of the pitch measuring device including a housing including a housing base element and a housing top element;

FIG. 2 illustrates a perspective view of the inner elements of the housing top element;

FIG. 3 illustrates a sectional view of the pitch measuring device according to FIG. 1;

FIG. 4 illustrates a perspective view of a pitch measuring device including a pendulum element;

FIG. 5 illustrates a block diagram for a measurement without the pendulum element; and

FIG. 6 illustrates a block diagram for a measurement with two pendulum elements.

### DETAILED DESCRIPTION OF THE INVENTION

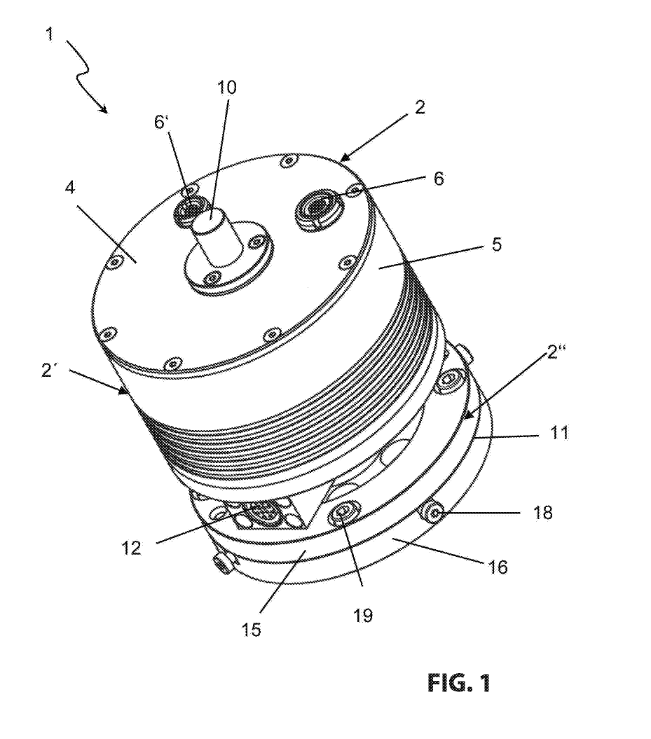

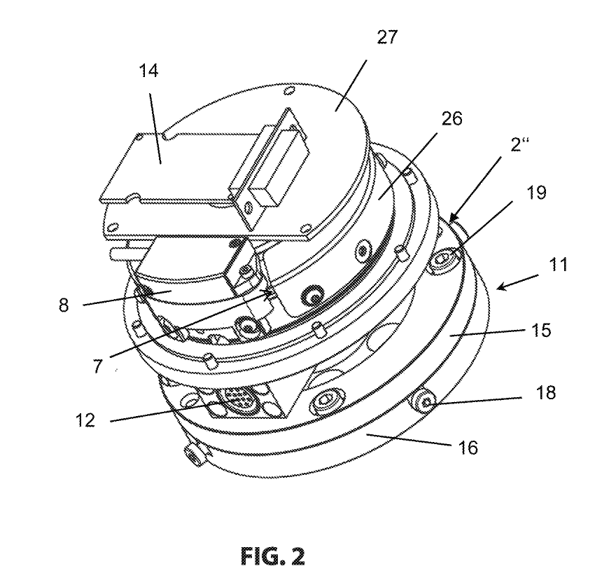

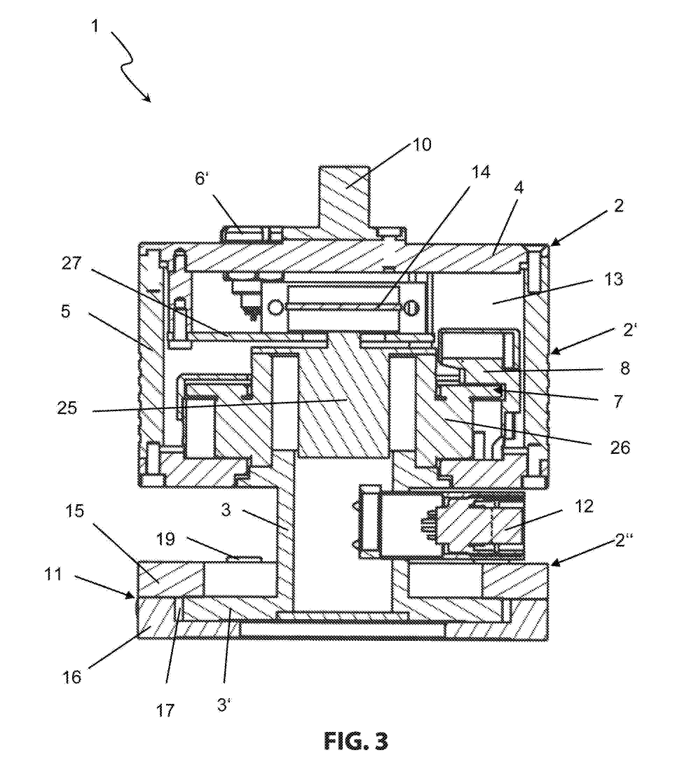

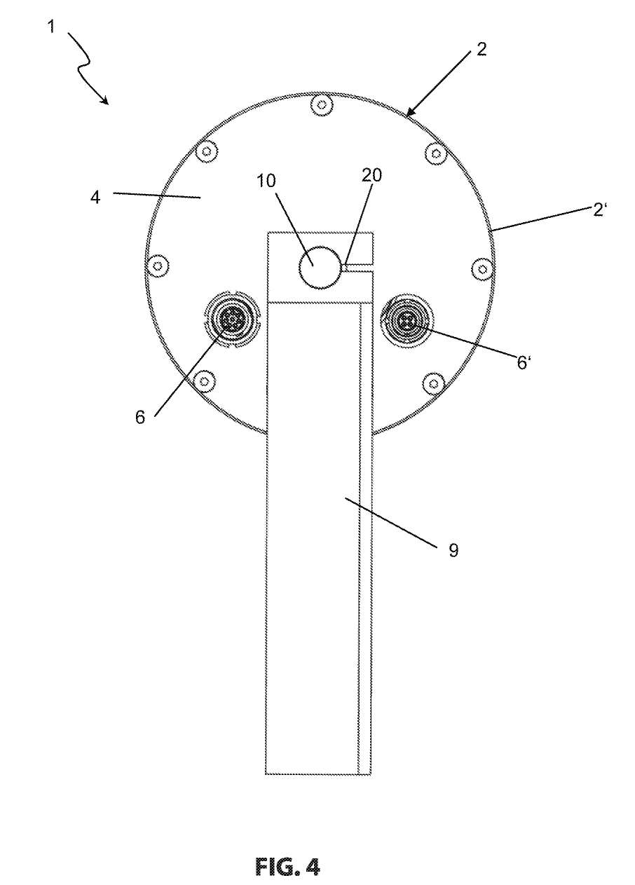

FIG. 1 illustrates the pitch measuring device 1 including a cylindrical housing 2 that includes a housing top element 2′ and a housing base element 2″. The housing top element 2′ and the housing base element 2″ are rotatable relative to each other through a rotation shaft 3 (FIG. 3) that is not visible in this illustration. The housing top element 2′ includes a housing cover 4 and a housing jacket 5. Individual connection jacks 6, 6′ are provided in the housing cover 4 wherein the connection jacks are provided as individual plug connectors for connecting connection cables for the respective measuring purposes. In this embodiment the connection jack 6 is used for data output of a rotary encoder 7 (FIGS. 2, 3) arranged in the housing top element 2′ for normal operations without additional sensors. The connection jack 6′ is required when the pitch measuring device 1 is additionally operated with an inclination sensor. In this case the connection socket 6 is not required. In the embodiment the connection jack 6 is provided with eight poles and the connection jack 6′ is provided with four poles. Centrally arranged and in an extension of the rotation shaft 3 and the rotation axis thus formed a clamping pin is arranged at the housing cover 4. The scanning rod arrangement that is typical for the measurement can be attached at the clamping pin 10 by a clamping element which is fixed with another end at a stationary machine element or a machine element relative to the moving machine element at which the housing 2 of the pitch measuring device 1 is attached. Thus, a rotation movement of the housing top element 2′ is prevented so that the measurement can be performed by the rotation of the housing base element 2″ relative to the housing top element 2′. The clamping pin 10 is simultaneously used for attaching a pendulum element with an inclination sensor 21 (FIG. 4) which is clamped together with the clamping pin 10.

The housing base element 2′ includes a base 11 that is offset from the housing top element 2′. The housing base element 2″ furthermore includes an additional jack 12 which is also used in a form of a combination plug connector as a data output for the signals from the rotary encoder 7 when the inclination sensor 21 is connected through the connection jack 6′. The jack 12 is configured as a 12 pole jack. The signals from the rotary encoder 7 and the connection jack 6′ are captured from the rotation shaft 3 by slip rings 25 (FIG. 3). Corresponding adapters for attaching and securely fixing the housing 2 can be attached in a known manner at the base 12 at a machine element that moves and is to be measured. The base 11 also includes adjustment devices with adjustment screws 18 that are externally accessible and offset from each other by 90° for orienting the housing top element 2′ relative to the housing base element 2″. For this purpose the base 11 includes a pressure plate 15 and an adjustment plate 16 which are connected with each other through screws 19 with plate springs.

FIG. 2 illustrates the embodiment in the upper housing top element 2′. At this location the rotary encoder 7 with a scanning head 8 and a bearing ring 26 with encoding and a substantially no clearance ball bearing are arranged and a converter circuit board 14 on a carrier circuit board 27 for the rotary encoder 7 which circuit board is attachable at the housing cover 4. The converter circuit board 14 has connections for the rotary encoder 7 and the connection jack 6, 6′ and is also used to amplify and process the analog sine shaped signals.

The sectional view of FIG. 3 with a sectional line extending through the plug connector jack 12 and the scanning head 8 illustrates the housing jacket 5 with the housing cover 4 of the housing top element 2′ with the individual components in an interior of the housing top element 2′. The rotation shaft 3 associated with the housing base element 2′ and fixed at the base 11 and associated with the rotary encoder 7 is coaxial with the clamping pin 10. The bearing ring 26 with an encoding with 30,000 lines is arranged on the rotation shaft 3. This yields a measuring precision of±0.6 angle seconds. The exact angle position is then determined by the scanning head 8 with the respective precision. A slip ring 25 transfers the signals to the plug in jack 12. On an inside of the housing cover 4 there is the converter circuit board 14 on which the signals supplied by the scanning head 8 or the connection jack 6′ are accordingly provided either to the connection jack 6 or the plug in jack 12 through respective cables that are not illustrated.

The housing base element 2″ includes the base 11 which is connected with the rotation shaft 3. The base 11 includes the upper pressure plate 15 and the lower actuation plate 16 wherein the pressure plate 15 is disengageable from the actuation plate 16 by the bolts 19 so that the rotation shaft 3 can be aligned in the radial direction with the rotation shaft base 3′ in a cavity 17 arranged in the actuation plate 16 wherein the alignment is performed by adjustment screws 18. After the adjustment the pressure plate 15 can be bolted to the actuation plate 16 by bolts 19 with plate springs so that the rotation axis of the rotation shaft 3 is fixed. Through the radial movement of the rotation shaft 3 also the housing top element 2 is aligned accordingly.

The pitch measuring device 1 illustrated in FIGS. 1-3 facilitates measurements in all positions in space of the moving machine component. In FIG. 4 the pitch measuring device 1 is illustrated with a pendulum element 9 arranged at the housing top element 2′. In this application of the pitch measuring device 1 the pitch measuring device is attached at the moving machine element so that the rotation shaft 3 or the rotation axis is horizontal. Only for this configuration a measurement with the pendulum element 9 is possible. The pendulum element 9 is fixed with a clamping opening 20 at the clamping pinion 10 and thus arranged so that the pendulum element 9 is disposed between the two connection jacks 6, 6′. The pendulum element 9 includes a non-illustrated inclination sensor 21 in an interior of the pendulum element wherein the inclination sensor detects deviations from vertical and a converter circuit board 14. The inclination sensor 21 is thus also connected with the connection jack 6′ through a connection cable that is also not illustrated.

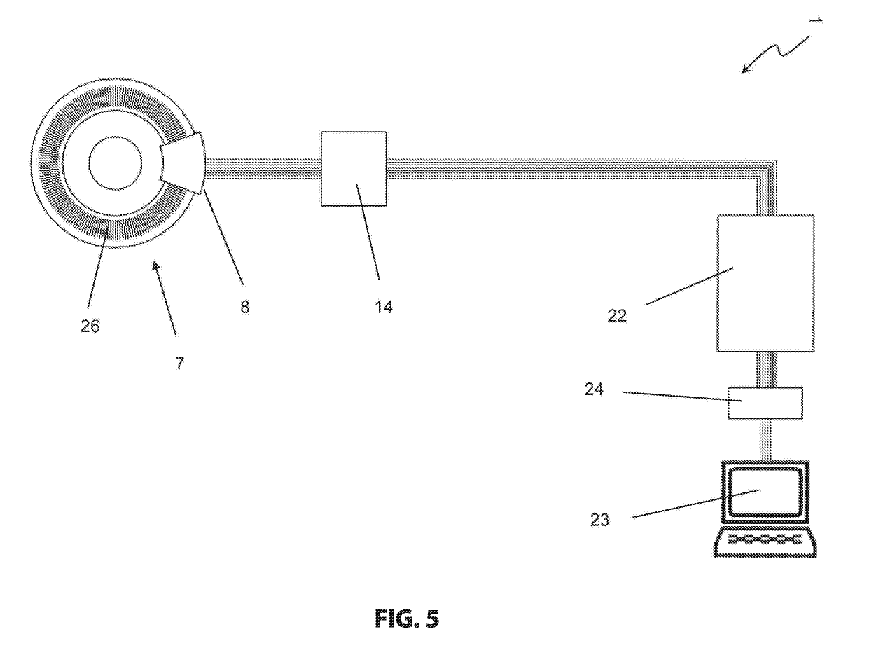

FIG. 5 illustrates the circuit arrangement for the major portion of the measurements without the pendulum element 9. The measurement values are transmitted by the scanning head 8 through corresponding 8 strand cables to the converter circuit board 14 and through the connection jack 6 and a connection cable plugged into it to an analog digital converter 22 in which the analog signals are digitized. Thereafter the digital signals are transmitted through a corresponding connection converter 24 (USB) to a computer with an input unit 23. There the deviations from the nominal value are determined by addition or subtraction. The converter circuit board 14 is used for signal amplification and signal processing for the signals provided by the scanning head 8.

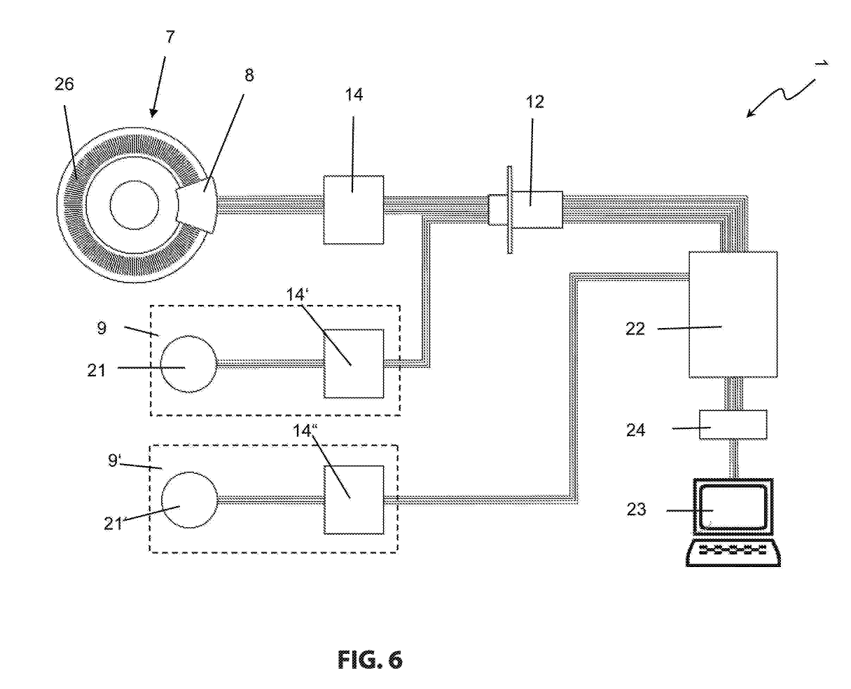

In order to perform the measurement using a pendulum element 9 drawn in dashed lines at the housing 2 it is necessary to arrange a second pendulum with another inclination sensor 21′ that is also drawn in dashed lines and configured accordingly at the machine frame of the machine. FIG. 6 illustrates the associated circuitry. According to FIG. 6 an analog digital converter 22 is provided which digitizes the input signals. The actual rotation angles supplied by the scanning head 8 with the changes provided by the inclination sensors 21 and 21′ relative to the position at the beginning of the measurement are corrected by addition or subtraction in the computer 23. The determined correction values are either put in by hand through the computer or through the input terminal 23 or directly into the machine control. The signals captured by the scanning head 8 are provided through an 8 strand cable to the converter circuit board 14. The measurement values of the inclination sensor 21 of the pendulum element 9 are transmitted to a converter circuit board 14′ and through the jack 6′ to the rotation shaft 3 with the slip ring and are transmitted through the plug in jack 12 to the AD converter 22.

Through the jack 12 also the inclination sensor 21′ in a pendulum element 9′ that is attached at the machine frame is connected through a converter circuit board 14″ arranged in the pendulum element 9′ is connected with the A/D converter 22. The connection cables to the inclination sensors 6, 6′ have four strands. The converter circuit board 14′ and the converter circuit board 14″ are used for signal amplification and signal processing of the analog signals like the converter circuit board 14.

What is claimed is:

1. A pitch measuring device for checking a positioning precision of a machine element of a machine, the machine element moving along an at least two dimensional movement path, the pitch measuring device comprising:
a housing including
attachment devices for attachment of the housing at the machine element,
an integrated measuring device that is arranged in the housing,
a centrally arranged rotation shaft,
a rotary encoder for detecting an angular position of the rotary encoder relative to the rotation shaft,
wherein the housing includes a housing base element and a housing top element that is rotatably arranged relative to the housing base element through the rotation shaft that is centrally arranged and attached torque proof at the housing base element,
wherein the rotary encoder is arranged in the housing top element and the housing base element includes the attachment devices.

2. The pitch measuring device according to claim 1, wherein the housing top element includes a clamping pin that is arranged in alignment with an axis of the rotation shaft.

3. The pitch measuring device according to claim 1, wherein the housing top element includes a housing cover and a housing jacket.

4. The pitch measuring device according to claim 1, wherein the housing top element includes electrical connection devices configured as plug connectors for different operating modes of the pitch measuring device.

5. The pitch measuring device according to claim 1,
wherein the housing base element includes a plug connector which is connected with the housing top element through slip contacts, and
wherein the slip contacts are connected with plug connectors or an electronic circuitry in an electrically conductive manner.

6. The pitch measuring device according to claim 1,
wherein the housing base element includes a base that includes a pressure plate and with an actuation plate,
wherein the actuation plate is provided for attachment of the housing base element at the machine element and the pressure plate clamps a base of the rotation shaft with the actuation plate, and
wherein orientation devices are arranged between the actuation plate and the pressure plate.

7. The pitch measuring device according to claim 1, further comprising an external data unit that is connectable with a computer, wherein the external data unit is connectable or connected at a plug connector or at other measuring elements.

8. The pitch measuring device according to claim 1 further comprising, a first inclination sensor that is attachable at the housing top element and a second inclination sensor that is attachable directly at a frame element of the machine.

9. The pitch measuring device according to claim 8, wherein a first pendulum element which is removably attached or attachable at a clamping pin of the housing top element includes the first inclination sensor and a second pendulum element that is directly attachable at the frame element of the machine includes the second inclination sensor.

10. The pitch measuring device according to claim 8,
wherein the housing base element includes a combined data output for the rotary encoder and the first inclination sensor,
wherein the combined data output is configured as a combination plug connector or the housing top element includes a respective data output for the rotary encoder and a respective data input for the inclination sensor arranged at the housing top element, and
wherein the respective data outputs are configured as individual plug connectors.

11. A method comprising the steps:
moving a machine element of a machine along a movement path that is at least two dimensional, and
checking a positioning precision of the machine element by a pitch measuring device, the pitch measuring device including:
a housing including
attachment devices for attachment of the housing at the machine element,
an integrated measuring device which includes a centrally arranged rotation shaft and a rotary encoder in the housing for detecting an angular position of the rotary encoder relative to the rotation axle,
wherein the housing is arranged at the machine element performing the movement path with the horizontal rotation shaft,
wherein a first inclination sensor is arranged at the housing and a second inclination sensor is arranged at a frame element of the machine and data provided by the first inclination sensor and the second inclination sensor during a position change of the machine is computed with data determined by the rotary encoder.

12. The method according to claim 11, wherein measurement values provided by the first inclination sensor and the second inclination sensor are zeroed before the measurement.

13. The method according to claim 11, wherein deviations from an original position at a beginning of a measurement are added to or subtracted from measurement values provided by the rotary encoder.

14. The method according to claims 11, wherein a pitch measuring device according to claim 1 is used.
